(19) United States
(12) Patent Application Publication
(10) Pub. No.: US 2001/0023397 A1
(43) Pub. Date: Sep. 20, 2001

(54) Conversation processing apparatus, method therefor, and recording medium therefor

(76) Inventors: Kazuhiko Tajima, Tokyo (JP); Masanori Omote, Kanagawa (JP); Hongchang Pao, Tokyo (JP); Atsuo Hiroe, Kanagawa (JP); Hideki Kishi, Tokyo (JP); Masashi Takeda, Tokyo (JP)

Correspondence Address: William S. Frommer, Esq., FROMMER LAWRENCE & HAUG LLP, 745 Fifth Avenue, New York, NY, 10151, US

(21) Appl. No.: 09/748,879

(22) Filed: Dec. 26, 2000

(30) Foreign Application Priority Data
Dec. 28, 1999 (JP) 11-373778

(51) Int. Cl. G10L 15/00

(52) U.S. Cl. 704/231

(57) ABSTRACT

A highly reliable speech dialog apparatus is provided. A plurality of speech recognition results are input into a language processor. Among the plurality of recognition results, the language processor outputs only the grammatically correct recognition results to a dialog controller. The dialog controller selects a recognition result which matches a corresponding frame. A response sentence generator then generates a response sentence in such a manner that slots within the frame are filled in.

### BACKGROUND OF THE INVENTION

1. Field of the Invention

The present invention generally relates to conversation processing apparatuses, methods therefor, and recording media therefor. More particularly, the present invention relates to a conversation processing apparatus and a method therefor suitable for use in an apparatus for performing predetermined speech processing. The invention also pertains to a recording medium for storing a program implementing the above-described method.

2. Description of the Related Art

FIG. 1 is a schematic block diagram illustrating an example of a speech dialog apparatus for performing predetermined processing, such as reservations of airline tickets, using speech. User's speech, which is transmitted via, for example, a telephone line, is input into a speech recognition unit 1. The speech recognition unit 1 then converts the user's speech into text data (or a word graph), and outputs it to a conversation processing unit 2.

The conversation processing unit 2 analyzes the input text data (and additional information) according to processing discussed below and creates text data of a response sentence based on the analysis result, and outputs it to a speech synthesizer 3. The speech synthesizer 3 then performs speech synthesis based on the received text data and outputs the synthesized speech to, for example, a telephone line. The user listens to the speech transmitted via the telephone line, and proceeds to a subsequent step. By repeating the above-described process, the reservation of airline tickets, for example, can be made.

FIG. 2 illustrates a detailed configuration of the conversation processing unit 2. A recognition result (in this example, text data) output from the speech recognition unit 1 is input into a language processor 11 of the conversation processing unit 2. The language processor 11 conducts analyses, such as morpheme analyses and syntax analyses, of the received recognition result based on data stored in a dictionary database 12 and an analysis grammar database 13, and extracts language information, such as word information and syntax information. The language processor 11 also extracts the meaning and intention of the input speech based on the data described in the dictionary.

More specifically, the dictionary database 12 stores the notation of words, word-class information required for applying the analysis grammar to the input speech, semantic information of the individual words, etc. The analysis grammar database 13 stores data concerning restrictions on the word collocation based on the information of the words stored in the dictionary database 12. By using such data, the language processor 11 analyzes the text data of the recognition result of the input speech.

The analysis grammar database 13 stores data required for performing text analyses using regular grammar, context-free grammar, the establishment of statistical word collocation, and a language theory including semantics, such as the head driven phrase structure grammar (HPSG), if semantic analyses are conducted.

A dialog controller 14 outputs a result processed by the language processor 11 to a frame matching portion 15. The frame matching portion 15 extracts data which is likely to match a frame in accordance with the transition of a topic from the user's speech. Upon filling in the frame, the frame matching portion 15 takes a predetermined action. This technique is referred to as a “frame filling method” or a “form filling method”, which is a dialog processing method, used in a cooperative task-oriented dialog system.

Details of the frame filling method are discussed in “Survey of the State of the Art in Human Language Technology”, R. Cole, et al, Cambridge University Press, 1998. Details of the form filling method are discussed in “Form-Based Reasoning for Mixed-Initiative Dialogue Management in Information-Query System”, Jennifer Chu-Carrol, ESCA, Eurospeech, 99 Proceedings, Budapest, Hungary, ISSN 1018-4074, pp. 1519-1522.

The dialog controller 14 acquires required information to fill in a frame by searching a knowledge database 16. The knowledge database 16 contains various databases of common knowledge, language knowledge, etc.

If suitable data is found after searching the knowledge database 16, the dialog controller 14 generates semantic information for issuing the actual speech and outputs it to a response sentence generator 17. The response sentence generator 17 analyzes the received semantic information and creates text data as a response sentence according to data stored in a response rule database 18. The data stored in the response rule database 18 includes a dictionary of word-class information and the word inflection required for generating response sentences, a dictionary of inflection rules and information for restricting the word order required for generating sentences, and so on.

The text data of the response sentence generated by the response sentence generator 17 is output to the speech synthesizer 3. The speech synthesizer 3 converts the text data into speech data, and transmits it to the user.

The language processor 11 of the conversation processing unit 2 is not always able to process the user's speech with a probability of 100 percent. Also, the speech recognition unit 1 is not always able to recognize the user's speech with a probability of 100 percent.

An example of a dialog between a speech dialog apparatus and a user is discussed below with reference to FIG. 3. At time t1, the speech dialog apparatus issues speech, “please say your departure place”. Then, at time t2, the user replies to the speech of the speech dialog apparatus, “from Tokyo”. At time t3, upon receiving the user's reply, the speech dialog apparatus, and more specifically, the speech recognition unit 1 and the conversation processing unit 2, perform the above-described processing. As a result of this processing, it is assumed that an incorrect speech recognition result, “to Tokyo”, is obtained.

The data output from the speech recognition unit 1 (language processor 11) to the dialog controller 14 is only the most likely speech to be issued by the user (most likely recognition result). In other words, even if the language processor 11 has extracted a plurality of likely recognition results, only the most likely recognition result is to be processed by the dialog controller 14 and the response sentence generator 17.

Accordingly, if the first recognition result is incorrect, the subsequent processing cannot be executed. In the example shown in FIG. 3, since the speech dialog apparatus instructs the user to input the departure place, a reply, “to Tokyo” is not appropriate. Thus, it is determined by the frame matching portion 15 that such a result does not match the frame. As a result, at time t3, the response sentence generator 17 generates text data, “please say your departure place once again”, and the speech synthesizer 3 converts the text data to an audio signal, and the corresponding speech is then issued to the user.

By being prompted to input the departure place once again, at time t4, the user repeats the same speech, “from Tokyo”. At time t5, the speech dialog apparatus correctly recognizes the user's speech. As a result, the dialog controller 14 determines that a reply matching the frame has been obtained, and generates text data corresponding to a subsequent question, “please say your destination”, and the speech synthesizer 3 converts it to an audio signal, and the corresponding speech is issued to the user.

As discussed above, even if a plurality of recognition results are extracted after recognizing the user's speech, only the most likely recognition result is used for speech recognition. Thus, if the most likely recognition result is incorrect, the speech dialog apparatus urges the user to issue the same speech once again, thereby reducing the reliability of the dialog apparatus.

### SUMMARY OF THE INVENTION

Accordingly, in view of the above background, it is an object of the present invention to improve the reliability of a dialog apparatus by using not only the most likely recognition result, but also the other likely recognition results for recognizing user's speech and by preventing the dialog apparatus from instructing the user to issue the same speech once again even if the recognition result is incorrect.

In order to achieve the above object, according to one aspect of the present invention, there is provided a conversation processing apparatus including a receiving unit for receiving user's speech. A first output unit recognizes the user's speech received by the receiving unit and outputs a plurality of likely recognition results. A second output unit outputs, among the plurality of likely recognition results output from the first output unit, likely recognition results which are determined to be grammatically correct. A determining unit determines whether the grammatically correct likely recognition results output from the second output unit match a corresponding frame in order from the most likely recognition result.

According to another aspect of the present invention, there is provided a conversation processing method including: a first output step of recognizing received user's speech and of outputting a plurality of likely recognition results; a second output step of outputting, among the plurality of likely recognition results output in the first output step, likely recognition results which are determined to be grammatically correct; and a determining step of determining whether the grammatically correct recognition results output in the second output step match a corresponding frame in order from the most likely recognition result.

According to still another aspect of the present invention, there is provided a recording medium for storing a computer-readable program which includes: a first output step of recognizing received user's speech and of outputting a plurality of likely recognition results; a second output step of outputting, among the plurality of likely recognition results output in the first output step, likely recognition results which are determined to be grammatically correct; and a determining step of determining whether the grammatically correct recognition results output in the second output step match a corresponding frame in order from the most likely recognition result.

According to the aforementioned conversation processing apparatus, the conversation processing method, and the recording medium, the user's speech is first recognized. As a result, a plurality of likely recognition results are output. Then, only the grammatically correct results are output, and it is determined whether they match a corresponding frame in order from the most likely recognition result. It is thus possible to provide a highly reliable conversation apparatus.

### BRIEF DESCRIPTION OF THE DRAWINGS

FIG. 1 illustrates an example of the configuration of a conventional speech dialog apparatus;

FIG. 2 illustrates the configuration of a dialog processing unit 2 shown in FIG. 1;

FIG. 3 illustrates a dialog conducted between the speech dialog apparatus shown in FIG. 1 and a user;

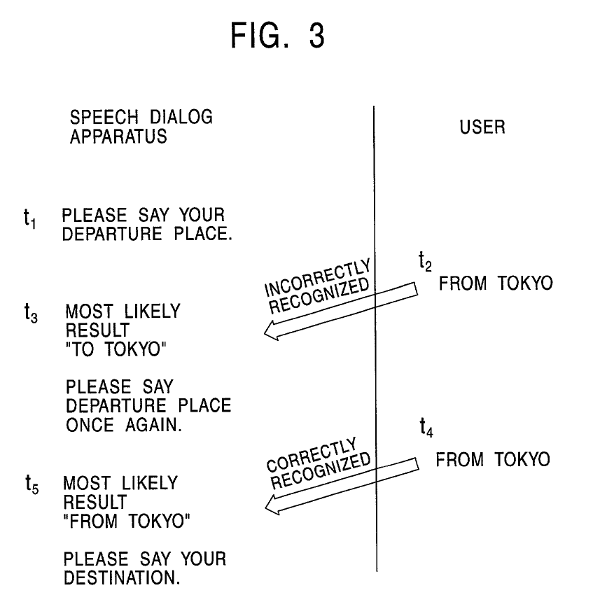

FIG. 4 illustrates a speech dialog apparatus according to an embodiment of the present invention;

FIG. 5 illustrates the configuration of a speech recognition unit 1 shown in FIG. 4;

FIG. 6 illustrates the configuration of a conversation processing unit 21 shown in FIG. 4;

FIG. 7 illustrates a frame;

FIG. 8 is a flow chart illustrating the operation of a language processor 51 shown in FIG. 6;

FIG. 9 is a flow chart illustrating a dialog controller 52 shown in FIG. 6;

FIG. 10 illustrates a dialog conducted between the speech dialog apparatus shown in FIG. 4 and a user;

FIG. 11 illustrates the configuration of a speech synthesizer 3 shown in FIG. 4; and

FIG. 12 illustrates media in which a program implementing the conversation processing method of the present invention may be stored.

### DESCRIPTION OF THE PREFERRED EMBODIMENTS

An embodiment of the present invention is described below in detail with reference to the drawings.

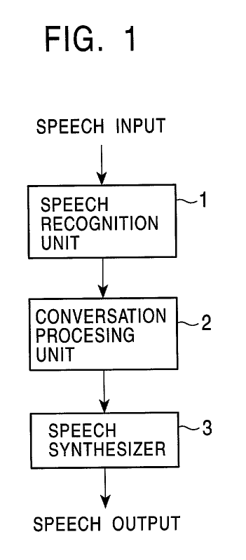

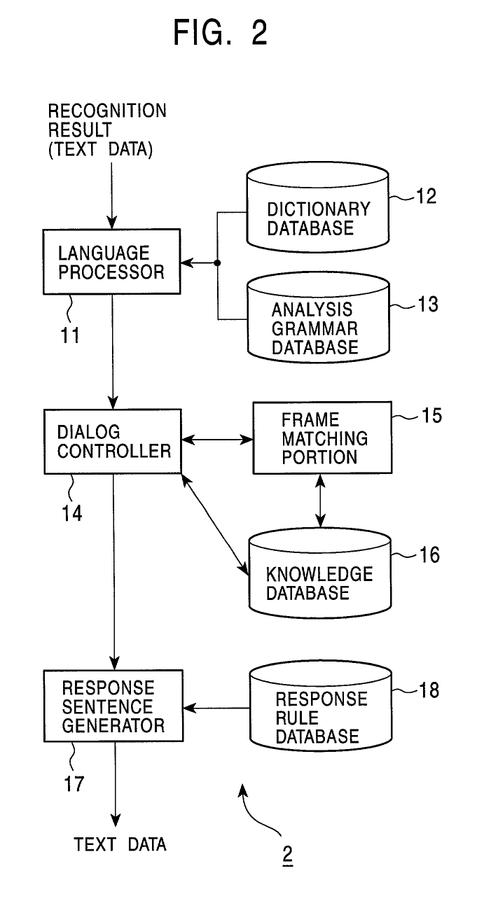

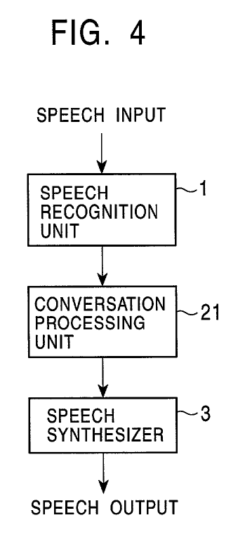

FIG. 4 illustrates the configuration of a speech dialog apparatus according to an embodiment of the present invention. In FIGS. 4 through 6, the same elements as those shown in FIGS. 1 and 2 are designated with like reference numerals, and an explanation thereof will thus be omitted.

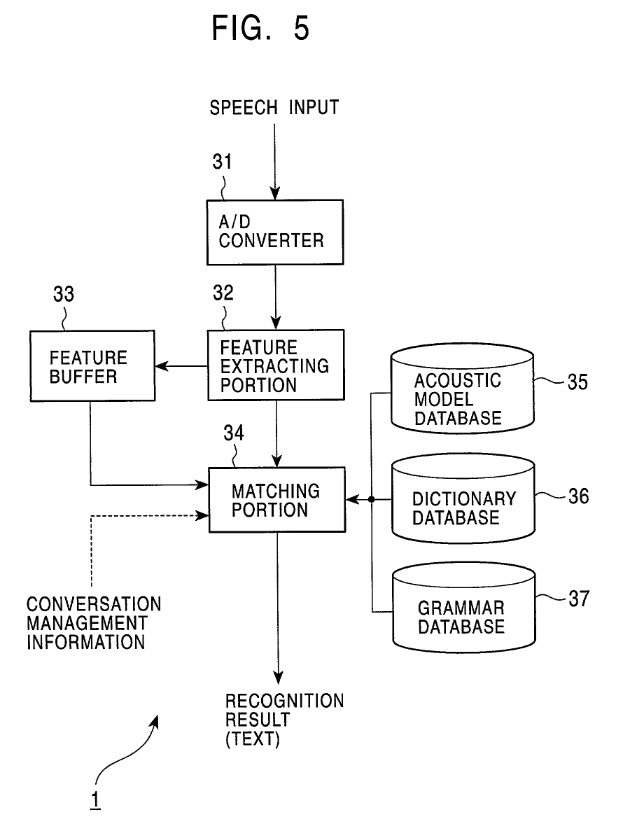

The speech dialog apparatus shown in FIG. 4 is configured such that the conversation processing unit 2 shown in FIG. 1 is replaced with a conversation processing unit 21. FIG. 5 illustrates a detailed configuration of the speech recognition unit 1. User's speech, which is transmitted via, for example, a telephone line, is input into an analog-to-digital (A/D) converter 31 of the speech recognition unit 1 as an audio signal. In the A/D converter 31, the analog audio signal is sampled, quantized, and converted into digital audio data. The audio data is then supplied to a feature extracting portion 32.

The feature extracting portion 32 extracts feature parameters, such as the spectrum, a linear prediction coefficient, a cepstrum coefficient, and a line spectrum pair, of each frame of the audio data from the A/D converter 31, and supplies them to a feature buffer 33 and a matching portion 34. The feature buffer 33 temporarily stores the feature parameters from the feature extracting portion 32.

The matching portion 34 recognizes the input audio signal based on the feature parameters supplied from the feature extracting portion 32 or the feature parameters stored in the feature buffer 33 by referring to an acoustic model database 35, a dictionary database 36, and a grammar database 37, as required.

More specifically, the acoustic model database 35 stores acoustic models representing acoustic features, such as individual phonemes and syllables, of the language of the speech to be recognized. As the acoustic models, Hidden Markov Models (HMM) may be used. The dictionary database 36 stores a word dictionary indicating the pronunciation models of the words to be recognized. The grammar database 37 stores grammar rules representing the collocation (concatenation) of the individual words registered in the word dictionary of the dictionary database 36. The grammar rules may include rules based on the context-free grammar (CFG) and the statistical word concatenation probability (N-gram).

The matching portion 34 connects acoustic models stored in the acoustic model database 35 by referring to the word dictionary of the dictionary database 36, thereby forming the acoustic models (word models) of the words. The matching portion 34 then connects some word models by referring to the grammar rules stored in the grammar database 37, and by using such connected word models, recognizes the input speech based on the feature parameters according to, for example, the HMM method. The speech recognition result obtained from the matching portion 34 is output in the form of, for example, text.

The matching portion 34 is adapted to receive information obtained in the conversation processing unit 21. This enables the matching portion 34 to perform speech recognition with high precision.

The speech recognition unit 1 outputs a plurality of recognition results to the conversation processing unit 21. In other words, the speech recognition unit 1 outputs not only the most likely result selected according to the information, such as acoustic scores and language scores, but also the second and subsequent (lower) results, to the conversation processing unit 21. The number of likely recognition results to be output from the speech recognition unit 1 is determined by the processing performance of the speech dialog apparatus.

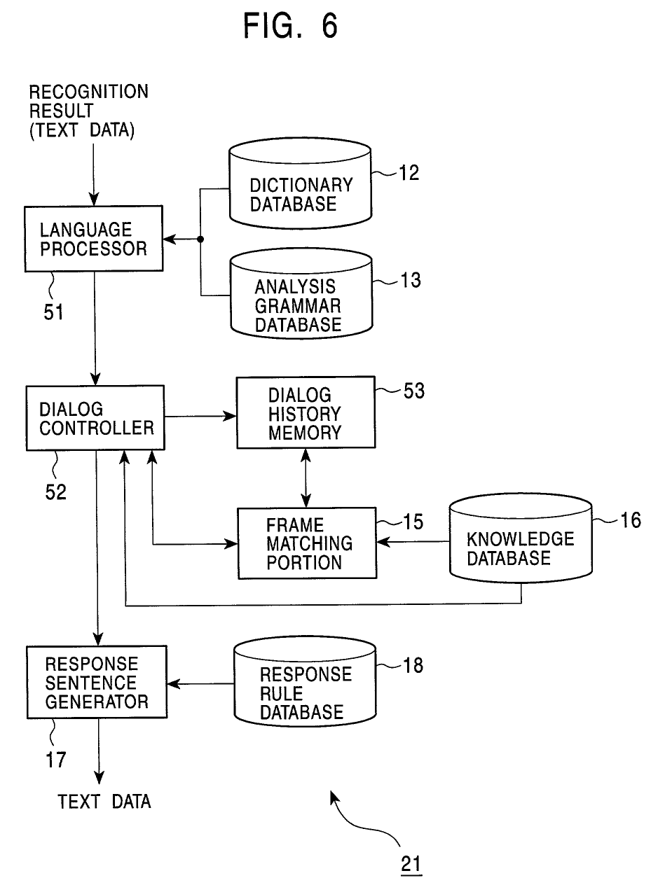

FIG. 6 is a block diagram illustrating the internal configuration of the conversation processing unit 21. A language processor 51 receives a plurality of recognition results output from the speech recognition unit 1 and analyzes them based on the data stored in the dictionary database 12 and the analysis grammar database 13. It is now assumed that the recognition result input from the speech recognition unit 1 indicates a verb (intransitive verb) together with a word which appears to be an object, even though the verb is an intransitive verb without an object. In this case, the language processor 51 determines that the recognition result is not appropriate, and does not output it to a dialog controller 52.

In this manner, among a plurality of recognition results input into the language processor 51, only results which are determined to be appropriate after being analyzed by the language processor 51 are output to the dialog controller 52. Accordingly, the number of recognition results input into the dialog controller 52 (output from the language processor 51) is equal to or smaller than that input into the language processor 51.

The dialog controller 52 selects the most likely result (first result) from the plurality of recognition results, and outputs the other results to a dialog history memory 53 and stores them therein. The dialog controller 52 selects the recognition result which matches the corresponding frame according to the frame filling method, and performs processing so that the slots within the frame are filled in.

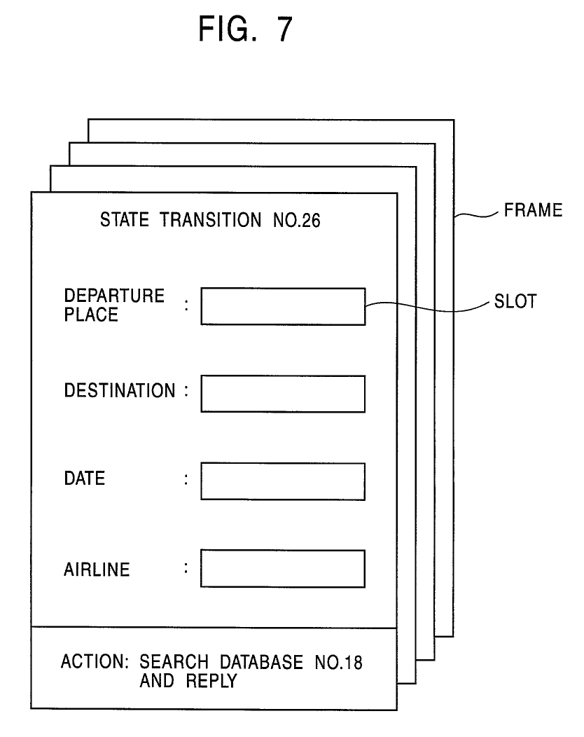

FIG. 7 illustrates an example of the frame. The frame shown in FIG. 7 is stored in the frame matching portion 15. The example shown in FIG. 7 is a frame for making a reservation of an airline ticket, and four slots, i.e., “departure place”, “destination”, “date”, and “airline”, are provided for state transition No. 26. The dialog controller 52 controls the dialog in such a manner that the slots are filled in. As the processing (action) to be performed after the slots are filled in, an instruction to “search database No. 18 and reply” is indicated.

In order to fill in the slots within the corresponding frame, the dialog controller 52 appropriately outputs information for creating a response sentence to the response sentence generator 17. For example, after the slot “departure place” is filled in, the dialog controller 52 outputs information for creating a reply sentence, “please say your destination”, to fill in the slot “destination” to the reply sentence generator 17.

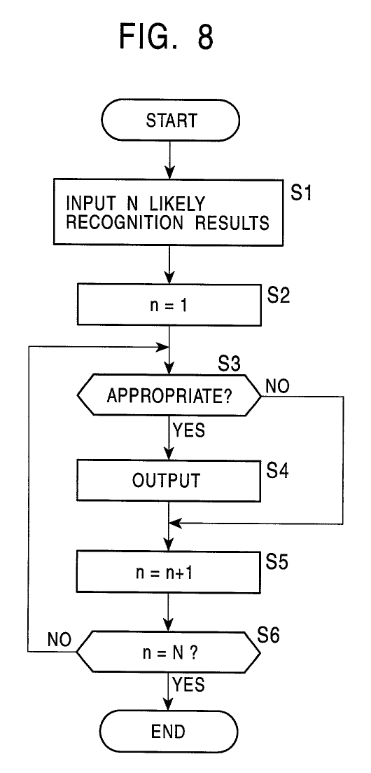

A description is now given of the operation of the language processor 51 of the conversation processing unit 21 with reference to the flow chart of FIG. 8.

In step S1, the 1st through N recognition results are input from the speech recognition unit 1. In step S2, setting of the initial recognition result to be processed is performed (n=1). That is, the most likely recognition result to be processed is determined based on acoustic scores and language scores.

It is then determined in step S3 whether the n-th likely result (in this case, the first recognition result) is appropriate. As discussed above, it is determined whether there are no inconsistencies in the recognition result to be processed by referring to the data stored in the dictionary database 12 and the analysis grammar database 13.

If it is determined in step S3 that the n-th recognition result is appropriate, the process proceeds to step S4. If not, the process skips step S4 and proceeds to step S5. In step S4, the n-th recognition result is output to the dialog controller 52.

In step S5, n is incremented by one. Then, it is determined in step S6 whether n is equal to N, namely, whether the newly set n-th recognition result is the final result input into the language processor 51. If it is found in step S6 that n is not equal to N, the process returns to step S3, and the corresponding processing is repeated.

If it is found in step S6 that n is equal to N, namely, that there is no recognition result left, the processing of the language processor 51 is completed.

As described above, the language processor 51 first determines whether a plurality of recognition results output from the speech recognition unit 1 are appropriate, and only the recognition results which are determined to be appropriate are output to the dialog controller 52.

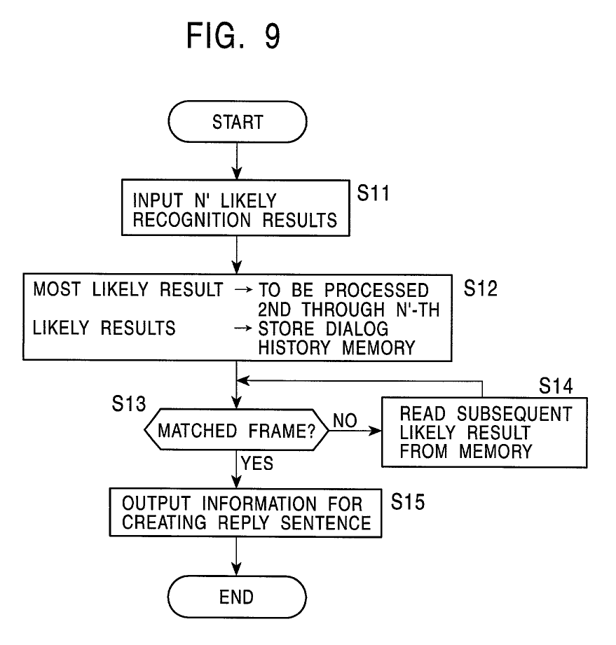

The operation of the dialog controller 52 is discussed below with reference to the flow chart of FIG. 9.

In step S11, the dialog controller 52 receives N′ recognition results, that is, from the 1st to the N′-th recognition results. In step S12, the dialog controller 52 selects the most likely result (first result) from the N′ input results, and outputs the other results (2nd through N′-th results) to the dialog history memory 53 and stores them therein.

It is then determined in step S13 whether the recognition result to be processed (in this case, the first result) matches the corresponding frame. If the outcome of step S13 is no, the second result is read from the dialog history memory 53. The processing of step S13 and the subsequent steps are then executed.

If it is found in step S13 that the recognition result to be processed matches the frame, the process proceeds to step S15. In step S15, information for creating a response sentence is output to the response sentence generator 17, and the processing of the dialog controller 52 is completed.

As discussed above, a plurality of recognition results obtained by the speech recognition unit 1 are input into the language processor 51. Then, the language processor 51 determines whether there are no inconsistencies in the input recognition results in terms of the language, in this case, Japanese. Then, only the recognition results which are determined to be appropriate are input into the dialog controller 52, and it is further determined by the dialog controller 52 whether they match the corresponding frame. Thus, even if the recognition result obtained by the speech recognition unit 1 is incorrect, the speech dialog apparatus can be prevented from instructing the user to issue the same speech once again.

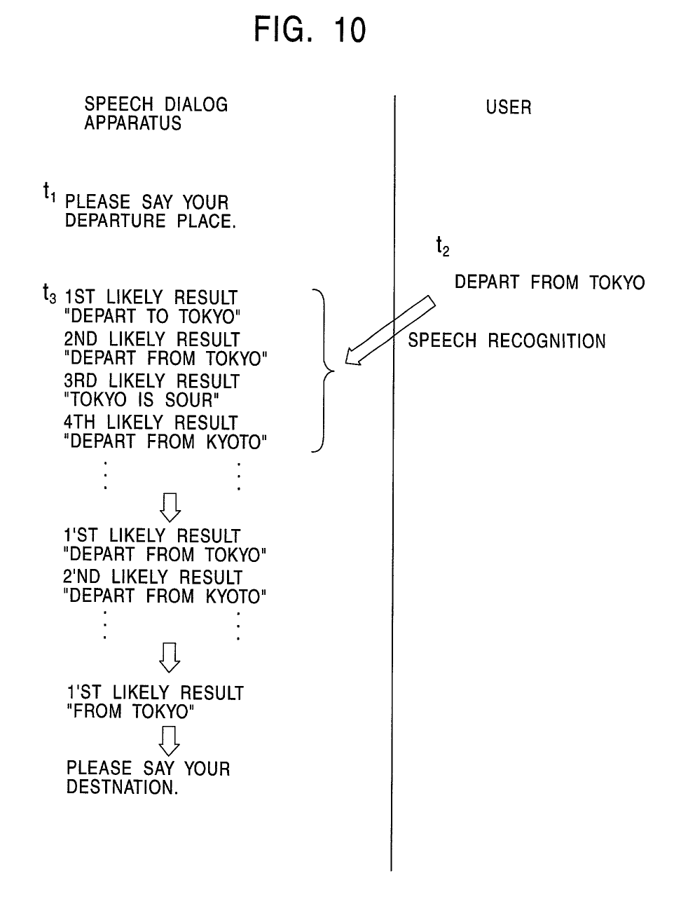

The processing executed in the conversation processing unit 21 is explained below with a specific example. As shown in FIG. 10, at time t1, the speech dialog apparatus issues the speech “please say your departure place”. Then, in response to this speech, at time t2, the user replies “depart from Tokyo”. Upon receiving the user's speech, the speech dialog apparatus, and more specifically, the speech recognition unit 1, recognizes the speech at time t3.

It is now assumed that a plurality of recognition results are obtained by the speech recognition unit 1, i.e., the most likely result “depart to Tokyo”, the 2nd likely result “depart from Tokyo”, the 3rd likely result “Tokyo is sour” (in Japanese, “depart” and “sour” are phonetically very similar), and the fourth likely result “depart from Kyoto”. The language processor 51 of the conversation processing unit 21 determines whether there are no inconsistencies in the plurality of recognition results in terms of Japanese. As a result, the 1st likely result “depart to Tokyo” and the 3rd likely result “Tokyo is sour” are determined to be inappropriate, and are not output to the dialog processor 52.

Then, the recognition result “depart from Tokyo”, which was previously the 2nd likely result, is input into the dialog controller 52 as the new first recognition result (hereinafter referred to as the 1'st recognition result), and the recognition result “depart from Kyoto”, which was previously the 4th recognition result, is input into the dialog controller 52 as the 2'nd recognition result. As a consequence, the dialog processor 52 determines that the 1'st result “depart from Tokyo” matches the slot “departure place” within the corresponding frame.

After filling in the slot “departure place”, the information for issuing the speech “please say your destination” is output to the response sentence generator 17 in order to fill in the slot “destination”. The response sentence generator 17 generates a response sentence as text data based on the input information, and outputs it to the speech synthesizer 3.

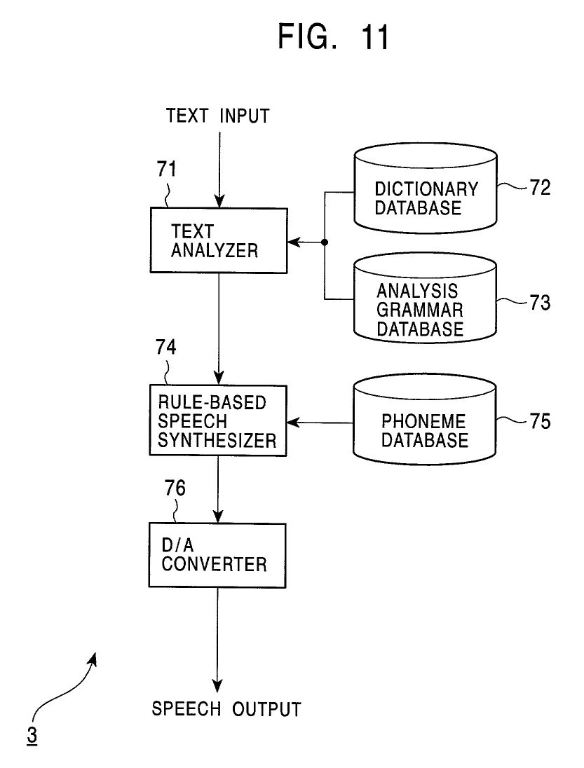

FIG. 11 illustrates an example of the configuration of the speech synthesizer 3. Text data output from the conversation processing unit 21 is input into a text analyzer 71. The text analyzer 71 then analyzes the text by referring to a dictionary database 72 and an analysis grammar database 73.

More specifically, a word dictionary describing word-class information, spelling, accent, etc. of each word is stored in the dictionary database 72. Analysis grammar rules, such as limitations concerning the word concatenation, for the words described in the word dictionary of the dictionary database 72 are stored in the analysis grammar database 73. Based on the word dictionary and the analysis grammar rules, the text analyzer 71 then conducts analyses, such as morpheme analyses and syntax analyses, of the input text, and extracts information required for rule-based speech synthesis to be performed in a rule-based speech synthesizer 74. The information required for rule-based speech synthesis includes information for controlling the positions of pauses, accents, and intonation, prosodic information, and modification information, such as pronunciations of each word.

The information obtained in the text analyzer 71 is supplied to the rule-based speech synthesizer 74. In the rule-based speech synthesizer 74, speech data (digital data) of the synthesized speech corresponding to the text input into the text analyzer 71 is generated by using a phoneme database 75.

More specifically, in the phoneme database 75, phoneme data is stored in the form of, for example, consonant, vowel (CV), VCV, CVC, etc. The rule-based speech synthesizer 74 connects required phonemes based on the information output from the text analyzer 71, and suitably adds pauses, accents, and intonation to the connected phonemes so as to create speech data of the synthesized speech corresponding to the text input into the text analyzer 71.

The speech data is then supplied to a digital-to-analog (D/A) converter 76 in which it is converted into an analog audio signal. The analog audio signal is supplied to, for example, a telephone line (not shown), so that the synthesized speech corresponding to the text input into the text analyzer 71 is transmitted to the user.

As described above, among the recognition results obtained by the speech recognition unit 1, not only the most likely result, but also the other likely results, are selected for processing. It is thus possible to provide a high-precision speech dialog apparatus, in other words, a speech dialog apparatus which can be prevented from instructing the user to repeat the same speech.

The above-described processing may be executed by hardware or software. If software is used to execute the above-described processing, it is installed from a recording medium into a computer which contains a special hardware integrating the corresponding software program or into a computer, for example, a general-purpose computer, which executes various functions by installing various programs.

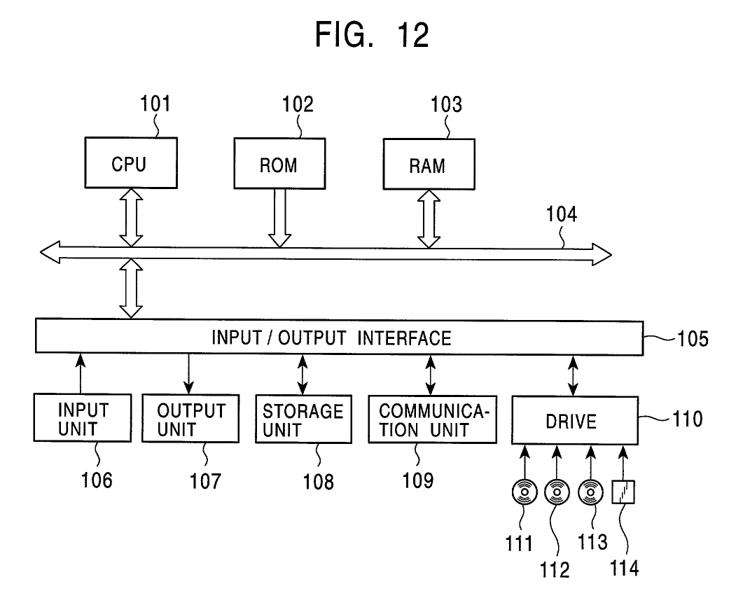

Such a recording medium is distributed to the user for providing the program, as shown in FIG. 12. The recording medium may be formed of a package medium, such as a magnetic disk 111 (including a floppy disc), an optical disc 112 (including compact disc-read only memory (CD-ROM) and a digital versatile disk (DVD)), a magneto-optical disk 113 (including a mini disk (MD)), or a semiconductor memory 114. Alternatively, the recording medium may be integrated into a computer in the form of, for example, a read only memory (ROM) 102 storing the corresponding program or a hard disk containing a storage unit 108, and may be provided.

It is not essential that the steps forming the program provided by a medium are executed chronologically according to the order discussed in this specification. Alternatively, they may be executed concurrently or individually.

The term, “system”, used in this specification represents the overall apparatus formed of a plurality of devices.

What is claimed is:

1. A conversation processing apparatus comprising:
receiving means for receiving user's speech;
first output means for recognizing the user's speech received by said receiving means and outputting a plurality of likely recognition results;
second output means for outputting, among the plurality of likely recognition results output from said first output means, likely recognition results which are determined to be grammatically correct; and
determining means for determining whether the grammatically correct likely recognition results output from said second output means match a corresponding frame in order from the most likely recognition result.

2. A conversation processing method comprising:
a first output step of recognizing received user's speech and of outputting a plurality of likely recognition results;
a second output step of outputting, among the plurality of likely recognition results output in said first output step, likely recognition results which are determined to be grammatically correct; and
a determining step of determining whether the grammatically correct recognition results output in said second output step match a corresponding frame in order from the most likely recognition result.

3. A recording medium for storing a computer-readable program which comprises:
a first output step of recognizing received user's speech and of outputting a plurality of likely recognition results;
a second output step of outputting, among the plurality of likely recognition results output in said first output step, likely recognition results which are determined to be grammatically correct; and
a determining step of determining whether the grammatically correct recognition results output in said second output step match a corresponding frame in order from the most likely recognition result.
